(19) United States
(12) Patent Application Publication
(10) Pub. No.: US 2026/0286912 A1
(43) Pub. Date: Sep. 24, 2026

(54) CALIBRATION SYSTEM AND METHOD FOR FUEL INJECTION CALIBRATION

(71) Applicant: Cummins Power Generation Inc., Minneapolis, MN (US)

(72) Inventors: Axel O. zur Loye, Battle Ground, WA (US); Andrew Guy Kitchen, Daventry (GB)

(73) Assignee: Cummins Power Generation Inc., Minneapolis, MN (US)

(21) Appl. No.: 19/083,259

(22) Filed: Mar. 18, 2025

(51) Int. Cl. F02D 41/30; F02D 19/06

(52) U.S. Cl. CPC F02D 41/3005; F02D 19/0602

(57) ABSTRACT

A system and method for fuel injection calibration are provided. The method includes adjusting a commanded engine fuel rate corresponding to a target load for an engine based on a comparison of the commanded engine fuel rate and an actual engine fuel rate, controlling a first fuel injector of an engine according to a first adjusted injector fuel rate for the first fuel injector, adjusting operation of the engine based on the first adjusted injector fuel rate and the target load for the engine, determining a first actual engine power output of the engine while operating the first fuel injector according to the first adjusted injector fuel rate and during the modified operation of the engine, and adjusting a first commanded injector fuel rate for the first fuel injector based on a comparison of the target load and the second actual engine power output.

### TECHNICAL FIELD

The present disclosure relates generally to methods for calibrating fuel injection systems within internal combustion engines.

### BACKGROUND

Internal combustion engines can include, for example, mono-fuel engine systems (e.g., using a single type of fuel) in addition to dual fuel engine systems that can operate using a combination of two different types of fuels. Such dual fuel engine systems can operate using a combination of a first fuel (e.g., a primary fuel), and optionally, a second fuel (e.g., a secondary fuel).

In an internal combustion engine system including a multi-cylinder engine (e.g., compression ignition or spark ignition internal combustion engines, etc.), fuel injected at an amount that differs from a desired amount due to fuel injector drift can cause engine damage and/or decreased engine performance. Typically, it can be difficult to determine whether the fuel injectors have drifted, and testing for fuel injector drift can cause an engine to run poorly during the testing.

### SUMMARY

At least one embodiment relates to a method of fuel injector calibration. The method includes adjusting a commanded engine fuel rate corresponding to a target load for an engine based on a comparison of the commanded engine fuel rate and an actual engine fuel rate, controlling a first fuel injector of an engine according to a first adjusted injector fuel rate for the first fuel injector, adjusting operation of the engine based on the first adjusted injector fuel rate and the target load for the engine, determining a first actual engine power output of the engine while operating the first fuel injector according to the first adjusted injector fuel rate and during the modified operation of the engine, and adjusting a first commanded injector fuel rate for the first fuel injector based on a comparison of the target load and the second actual engine power output. In some embodiments, adjusting operation of the engine includes controlling a second fuel injector of the plurality of fuel injectors to compensate for a reduced engine power output during operation of the first fuel injector according to the first adjusted injector fuel rate. In some embodiments, adjusting operation of the engine includes operating the first fuel injector to supply a primary fuel to the engine according to the first adjusted injector fuel rate, and operating a second fuel injector of the plurality of fuel injectors to supply a secondary fuel to compensate for a reduced engine power output during operation of the first fuel injector. In some embodiments, adjusting the first commanded injector fuel rate for the first fuel injector includes updating at least one of a function associated with the first commanded injector fuel or a lookup table associated with the first commanded injector fuel rate. In some embodiments, controlling the first fuel injector according to the first adjusted injector fuel rate includes disabling the first fuel injector or operating the first fuel injector at a partial level relative to a maximum operating capacity of the first fuel injector. In some embodiments, adjusting operation of the engine includes providing a power output to compensate for a reduced engine power output during operation of the first fuel injector according to the first adjusted injector fuel rate.

In some embodiments, the method further includes controlling a second fuel injector of the engine according to a second adjusted injector fuel rate for the second fuel injector, adjusting operation of the engine based on the second adjusted injector fuel rate and the target load, determining a second actual engine power output of the engine while operating the second fuel injector according to the second adjusted injector fuel rate and during the modified operation of the engine, and adjusting a second commanded injector fuel rate for the second fuel injector based on a comparison of the target load and the second actual engine power output. In some embodiments, the method further includes controlling the first fuel injector based on the adjusted first commanded injector fuel rate.

At least one embodiment relates to a calibration system for a plurality of fuel injectors of an engine. The calibration system includes a controller configured to select a first fuel injector of the plurality of fuel injectors, adjust operation of the first fuel injector, adjust operation of the engine to provide a power output based on adjusting the operation of the first fuel injector, determine a first actual engine power output of the engine responsive to adjusting the operation of the first fuel injector and the operation of the engine, and adjust a first commanded injector fuel rate of the first fuel injector based on a difference between the first actual engine power output and a target load of the engine. In some embodiments, the engine is configured to be fueled by a primary fuel and a secondary fuel. In some embodiments, the controller is configured to adjust the first commanded fuel injector rate by sending a command to update at least one of a function associated with the first commanded fuel injector rate or a lookup table associated with the first commanded fuel injector rate. In some embodiments, the controller is configured to adjust operation of the first fuel injector by reducing a fuel rate to the first fuel injector and adjust operation of the engine by increasing a fuel rate to one or more fuel injectors in the plurality of injectors. In some embodiments, the controller is configured to select a first fuel injector based on at least one of an engine vibration, an engine emission output, or an engine temperature.

In some embodiments, the calibration system includes a hybrid system including an electric motor and a battery, wherein the controller is configured to control the electric motor to provide a power output based on the target load and a reduced engine power output responsive to adjustment of the operation of the first fuel injector. In some embodiments, the controller is further configured to, in response to a difference between an adjusted first commanded injector fuel rate and the first commanded fuel injector rate being greater than an error margin, provide a signal indicating a defective injector. In some embodiments, the calibration system includes a generator configured to be driven by the engine. The controller is further configured to detect a voltage and a current of the generator to determine the first actual engine power output.

At least one embodiment relates to a method of calibrating fuel injection for a system including an engine. The method includes operating the engine at a target load and operating a plurality of fuel injectors of the engine. The method includes turning off a first fuel injector of the plurality of fuel injectors and compensating for a drop in engine power caused by turning off the first fuel injector by using power from a battery. The method further includes measuring the drop in engine power caused by turning off the first fuel injector, and repeating the preceding operations for each of the plurality of fuel injectors.

In some embodiments, the method further includes keeping operation of at least one of the plurality of fuel injectors fixed. In some embodiments, keeping the operation of the at least one of the plurality of fuel injectors fixed comprises keeping a fuel rate of the at least one of the plurality of fuel injectors fixed. In some embodiments, the method includes adjusting operation of at least one fuel injector of the plurality of fuel injectors to provide a power output to compensate for a reduced engine power output caused by turning off the first fuel injector.

It should be appreciated that all combinations of the foregoing concepts and additional concepts discussed in greater detail below are contemplated as being part of the subject matter disclosed herein. In particular, all combinations of claimed subject matter appended at the end of this disclosure are contemplated as being part of the subject matter disclosed herein.

### BRIEF DESCRIPTION OF THE FIGURES

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic diagram of a system, according to an embodiment.

FIG. 2 is a schematic diagram of a mono-fuel engine system, according to an embodiment.

FIG. 3 is a schematic diagram of a dual fuel engine system, according to an embodiment.

FIG. 4 is a schematic diagram of a controller for the dual fuel engine system of FIG. 3 or the mono-fuel engine system of FIG. 2, according to an embodiment.

FIG. 5 is a flow diagram of a method for calibrating fuel injection within an engine system, according to an embodiment.

FIG. 6 is a flow diagram of a method for calibrating fuel injection within an engine system, according to another embodiment.

FIG. 7 is a flow diagram of a method for calibrating fuel injection within the dual fuel engine system of FIG. 1, according to an embodiment.

FIG. 8 shows a flow diagram of a method for fuel injector calibration, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations can be utilized, and other changes can be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Embodiments described herein relate generally to calibrations systems, such as for a plurality of fuel injectors of an engine, methods of fuel injector calibration, and methods for calibrating fuel injection for a system including an engine. Such engines can be, for example, internal combustion engines. The internal combustion engines can be configured to use a primary fuel and a secondary fuel (e.g., a dual fuel system). Fuel injectors can be calibrated to provide improved engine performance, fuel efficiency, and/or emissions control.

In some embodiments, the first fuel can be a high cetane number fuel, such as diesel fuel, gas-to-liquid (GTL) diesel, heavy fuel oil (HFO), low sulfur fuel oil (LSFO), hydrotreated vegetable oil (HVO), marine gas oil (MGO), renewable diesel, biodiesel, paraffinic diesel, dimethyl ether (DME), F-76 fuel, F-34 fuel, jet A fuel, JP-4 fuel, JP-8 fuel, oxymethylene ether (OME), and the like. The second fuel can be, for example, a low cetane number fuel (e.g., a high octane number fuel, a high methane number fuel, natural gas, hydrogen, bio-gas, commercially available gas, gasoline, methane, ethane, propane (LPG), butane, ethanol, methanol, producer gas, field gas, nominally treated field gas, ammonia, well gas, nominally treated well gas, syngas, liquefied natural gas (LNG), compressed natural gas, landfill gas, condensate, coal-bed methane (CBM)) or liquid fuels that are readily vaporized (e.g., gasoline, etc.), and the like. The second fuel can be a biofuel (e.g., a liquid biofuel, such as methanol and/or ethanol), an e-fuel, and/or a low carbon fuel. Biofuels and/or low carbon fuels can reduce the environmental impact of engine operation by reducing both particulate matter emissions and carbon dioxide relative to engines that operate using diesel fuel alone. The first fuel and/or the second fuel can optionally be a blend of fuels.

The calibration system can be used to calibrate a plurality of fuel injectors (e.g., port fuel injectors, direct fuel injectors, dual fuel injectors etc.) of an engine. The calibration system can be used to detect injector drift for individual fuel injectors in the plurality of fuel injectors and correct (e.g., compensate) for the injector drift. In some embodiments, the plurality of fuel injectors can refer to any fuel delivery device that can control an amount of fuel that is delivered. For example, the plurality of fuel injectors can include various bodies, nozzles, and actuators. In another example, the plurality of fuel injectors can include fuel flow control valve which adjusts the amount of fuel. For example, the fuel flow control valves can adjust the amount of fuel that is delivered by adjusting one or more of: (i) how far the valve opens, (ii) how long the valve is open, or (iii) how often the valve is opened. Thus, the fuel flow control valves can be controlled to adjust any one of more of a valve opening extent, a valve opening duration, or a valve opening periodicity, alone or in any combination. In some embodiments, the calibration system can include a hybrid system including an electric motor and a battery or other energy storage device capable of providing electrical or mechanical power (e.g., a super capacitor, mechanical energy storage, etc.). In some embodiments, the calibration system can include a generator configured to be driven by the engine.

The calibration system can include a controller. The controller can operate the plurality of fuel injectors according to a commanded fuel rate corresponding to a target load for the engine (e.g., the plurality of injectors are injecting fuel at a rate corresponding to a requested engine power). Over time, however, the performance of fuel injectors can change (e.g., injector drift) such that there can be discrepancies (e.g., error, difference, etc.) between the commanded fuel rate (e.g., the amount of fuel that the injectors are commanded to deliver) and the actual fuel rate (e.g., the amount of fuel that is actually delivered). For example, a specific fuel rate may be commanded, but the actual fuel rate may be higher or lower due to injector drift. The controller can determine an actual engine fuel rate of the engine based on an actual engine power output of the engine, and adjust the commanded engine fuel rate based on a comparison of the commanded engine fuel rate and the actual engine fuel rate (e.g., compensate for the injector drift). In some embodiments, the controller can determine actual engine power output using the generator. The voltage and current (e.g., a kW-load signal) of the generator can be used to estimate an actual engine power output. The controller can adjust the commanded engine fuel rate, such as by updating fueling tables, to compensate for this error.

The present disclosure allows for control of engines, such as via the controller discussed above, for fuel injection at a desired amount. In mono-fuel engines (e.g., using a single type of fuel), the exemplary control techniques described herein can achieve improved performance, improved management of emissions, improved engine operation, and reduced risk of engine damage due to overfueling. In dual-fuel engines, the exemplary control techniques described herein can also avoid limiting the substitution rate (e.g., the ratio of secondary fuel to primary fuel) by better control of the actual amount of injected fuel.

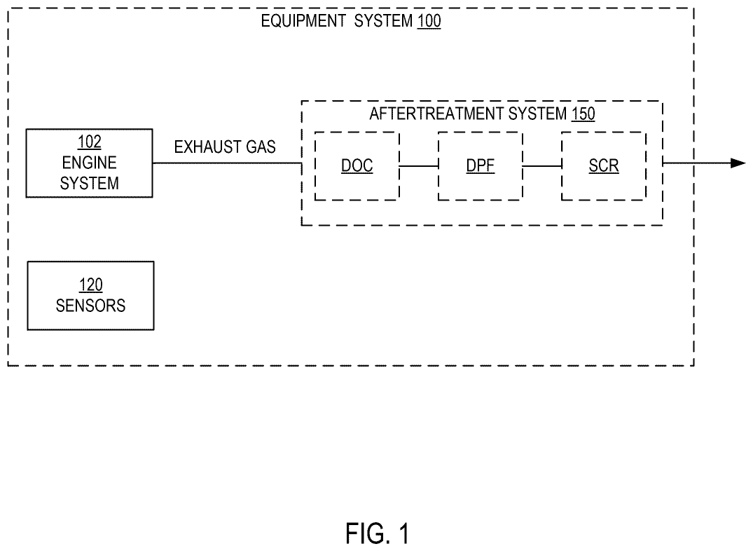

Referring now to FIG. 1, an example of a system 100 is shown. The system 100 can be equipment that is included in a vehicle, or in another system such as a stationary system. The vehicle can be an on-road or an off-road vehicle including, but not limited to, a line-haul truck, mid-range truck (e.g., a pick-up truck), a car, an autonomous vehicle, boat, tank, aircraft, locomotive, mining equipment, and any other type of vehicle that can utilize systems to reduce emissions. The vehicle can include a powertrain system, a fueling system, an operator input/output device, one or more additional vehicle subsystems, etc. The vehicle can include additional, fewer, and/or different components/systems, as the principles of the present disclosure are intended to be applicable with a variety of vehicle configurations. It should also be understood that the principles of the present disclosure should not be interpreted to be limited to vehicles; rather, the present disclosure is also applicable to stationary pieces of equipment such as a power generator or a generator set (genset). The system 100 is shown to include the engine system 102, an aftertreatment system 150 coupled with the engine system 102, and sensors 120.

The engine system 102 as shown in FIG. 1 is structured as a compression-ignition internal combustion engine system. In various embodiments, the engine system 102 can be structured as any of various types of internal combustion engine systems (e.g., spark-ignition) that utilize any type of fuel (e.g., gasoline, natural gas). The engine system 102 can be or include an electric motor (e.g., a hybrid drivetrain).

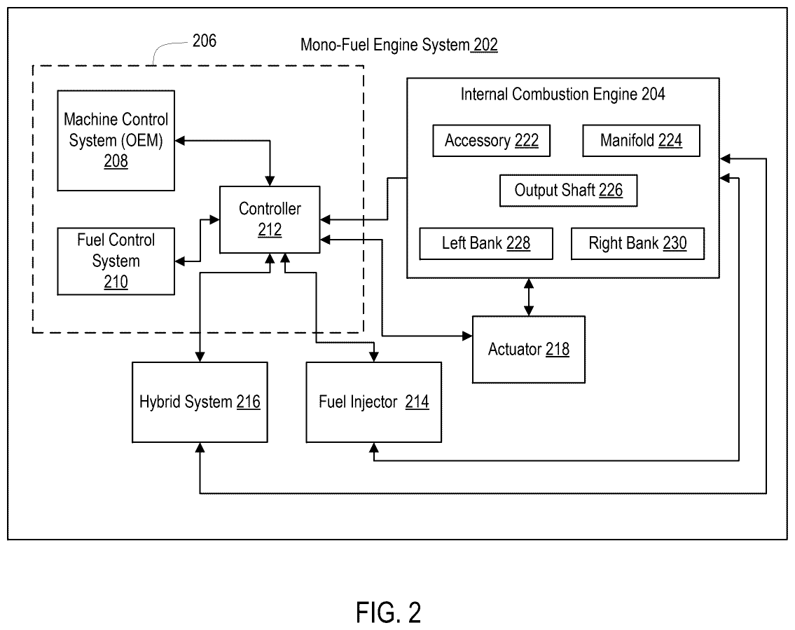

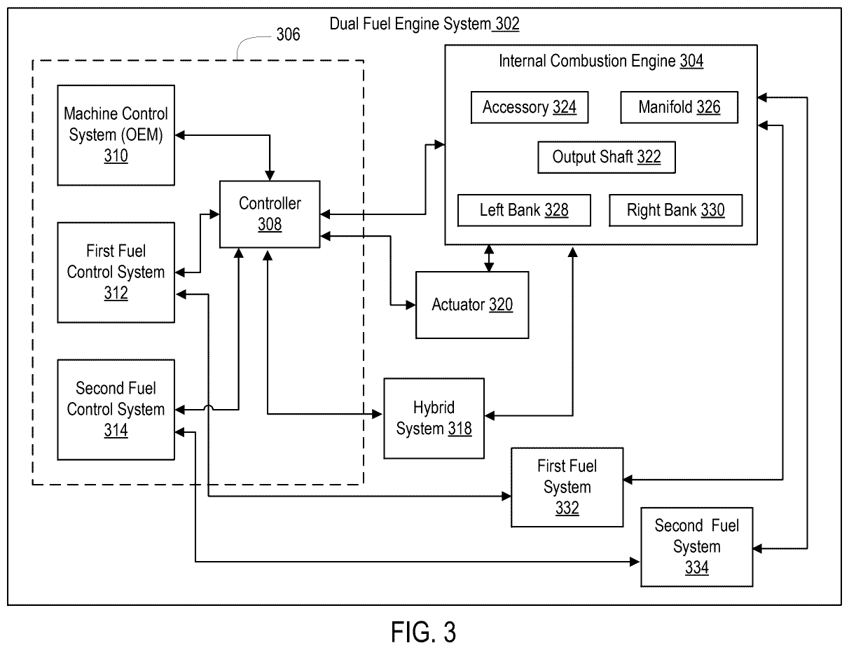

The engine system 102 includes one or more cylinders and associated pistons. Air from the atmosphere is combined with fuel, and combusted, to power the engine system 102. Combustion of the fuel and air in the combustion chambers within one or more cylinders of the engine system 102 produces exhaust gas that can be vented to an exhaust pipe and to the aftertreatment system. In some embodiments, the engine system 102 can be structured as a mono-fuel engine system as described in more detail below with regards to FIG. 2. In some embodiments, the engine system 102 can be structured as a dual fuel engine system as described in more detail below with regards to FIG. 3.

The aftertreatment system 150 is structured to receive exhaust gas from the engine system 102 and remove/mitigate harmful emissions from the exhaust gas before the exhaust gas is expelled to the environment. The aftertreatment system 150 can include one or more of a diesel oxidation catalyst (DOC), a diesel particulate filter (DPF), a selective catalytic reduction (SCR), or other aftertreatment components. Some embodiments may not include the aftertreatment system 150.

The sensors 120 are coupled with a controller associated with the system 100 (or of other systems/components of the associated vehicle). The controller is described in more detail with respect to FIGS. 2-4. The sensors are configured to detect and/or determine values associated with various properties of the system 100 and vehicle. Accordingly, the sensors 120 can include one or more of a temperature sensor, a pressure sensor, a particulate matter sensor, an emission sensor, a vibration sensor, a noise sensor, an engine speed sensor, an engine toque sensor, a power sensor, a vehicle speed sensor, an engine torque sensor, and one or more sensors for a fueling system. The temperature sensor can be, for example, a thermocouple or a resistance temperature detector to determine a temperature of one or more of the intake air, coolant, oil temperatures, or exhaust gas, for example. The pressure sensor can be configured to measure a pressure or a pressure change within the system 100. The particulate matter sensor can be configured to sense the amount of particulate matter in the exhaust gas. The emission sensor can be configured to determine a proportion of oxygen and nitrous oxides in the exhaust gas, which is indicative of the level of harmful emissions in the exhaust gas and thus the efficiency of the engine. The power sensor can be configured to measure the power of the engine system 102, and also the power of an alternator, the generator, or the battery by measuring the current and voltage. The sensors for the fueling system can be provided to determine a fuel injected quantity or a rail pressure, for example. In some embodiments, one or more of the sensors 120 are combined into a single sensor. In some embodiments, the sensors 120 are separate sensors. In some embodiments, a plurality of sensors 120 (e.g., a plurality of temperature sensors, a plurality of particulate matter sensors, and/or a plurality of emission sensors) can be used.

Referring to FIG. 2, a block diagram of an example of a mono-fuel engine system 202 is shown. The mono-fuel engine system 202 is an engine having a single fuel operation mode (e.g., is to operate using only a single fuel or blend of fuels received from a single source). The fuel can be, for example, the first fuel (or, in some embodiments, the second fuel) as described above.

As shown in FIG. 2, the mono-fuel engine system 202 includes an internal combustion engine 204, which is operably coupled with a control system 206 via at least one controller 212. The mono-fuel engine system 202 can include a hybrid system 216. The hybrid system 216 can be configured to generate power in the mono-fuel engine system 202. In some embodiments, the hybrid system 216 can be used to compensate for power that engine 204 cannot provide in response to a power request. In some embodiments, the hybrid system 216 can include a battery and an electric machine. In some embodiments, the engine 204 is a mono-fuel engine. The control system 206 can include at least one of a machine control system (OEM system) 208 or a fuel control system 210. The control system 206 can send one or more inputs to the controller 212, responsive to which the controller 212 can control the internal combustion engine 204. In various embodiments, the fuel control system 210 and its components are configured to operate using the fuel. In some embodiments, the fuel control system can be a gas fuel control system. In some embodiments, the fuel control system can be a liquid fuel control system. In various embodiments, the fuel control system 210 cooperatively operates within the internal combustion engine 204. In some embodiments, the internal combustion engine 204 is configured to be fueled by a primary fuel only.

In various embodiments, the controller 212 is configured to include a processor and a non-transitory computer readable medium (e.g., a memory device) having computer-readable instructions stored thereon that, when executed by the processor, cause the at least one controller 212 to carry out one or more operations. In various embodiments, the at least one controller 212 is a computing device (e.g., a microcomputer, microcontroller, or microprocessor). In some embodiments, the at least one controller 212 is configured as part of a data cloud computing system configured to receive commands from a user control device and/or remote computing device.

The controller 212 can include one or more processors and a memory. The one or more processors can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing a processor, ASIC, FPGA, etc. with program instructions. The memory can include a memory chip, Electrically Erasable Programmable Read-Only Memory (EEPROM), Erasable Programmable Read Only Memory (EPROM), flash memory, or any other suitable memory from which the controller can read instructions. The instructions can include code from any suitable programming language. The memory can include various modules that include instructions which are configured to be executed or otherwise implemented by the one or more processors. The subject matter including the operations described in this specification can be implemented in other types of digital electronic circuitry, or in computer software, firmware, or hardware, including the structures disclosed in this specification and their structural equivalents, or in combinations of one or more of them. The one or more processor and/or memory can be implemented as hardware for performing operations other than control operations, including but not limited to any of various data storage, communication, and/or processing operations.

The controller 212 can be at least partially implemented by or can be communicably coupled with any of various control hardware (not shown) associated with operation of the mono-fuel engine system 202, including but not limited to an engine control unit (ECU) or engine control module (ECM). In some embodiments, the controller 212 can receive or detect one or more signals, such as electrical signals or electronic signals, regarding operation of the mono-fuel engine system 202.

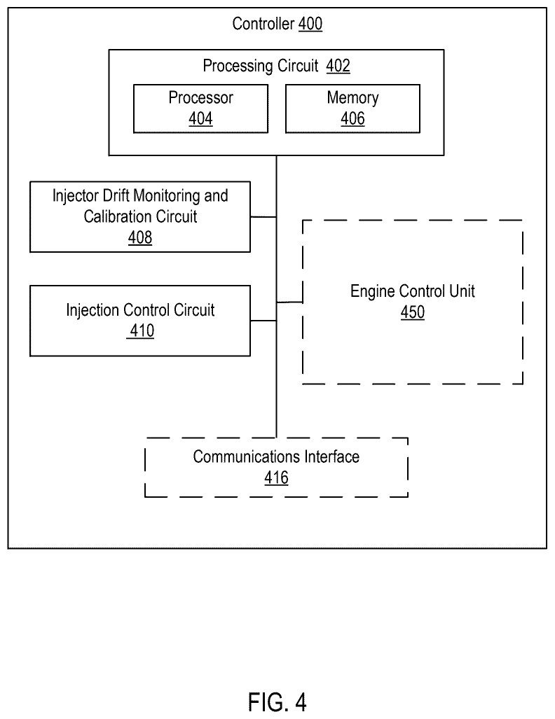

The controller 212 can be operably coupled with the at least one fuel injector 214 to facilitate injection of the fuel. The controller 212 can be operably coupled with and at least one actuator 218. In some embodiments, the fuel injector 214 is a gas injector. In some embodiments, the fuel injector 214 is a liquid fuel injector. In some embodiments, each of the fuel injector 214, and the actuator 218 are operably coupled with the internal combustion engine 204. In some embodiments, the hybrid system 216 can be operably coupled to the internal combustion engine 204. In other embodiments, the hybrid system 216 can be arranged such that it is not directly coupled to the internal combustion engine 204. In various embodiments, the fuel injector 214 is configured to control or facilitate injection of the fuel (e.g., gas or a liquid, or a second gas) into the internal combustion engine 204. The actuator 218 can include one or more first fuel type (e.g., diesel type or other liquid type, first gas type) actuators, air handling actuators, aftertreatment actuators, or any other type of actuator within the mono-fuel engine system 202. Accordingly, during operation, the controller 212 can send one or more inputs to one or more of the internal combustion engine 204, the fuel injector 214, the hybrid system 216, or the actuator 218 to facilitate operating the mono-fuel engine system 202 in a target mode of operation. The controller 212 is described in more detail with respect to FIG. 4.

As shown, the internal combustion engine 204 includes an output shaft 226 and can also include one or more accessories 222. The internal combustion engine 204 further includes at least one manifold 224. In various embodiments, the at least one manifold 224 includes, but is not limited to an intake manifold. The internal combustion engine 204 also includes at least one engine cylinder bank. In some embodiments, the at least one engine cylinder bank includes a left bank 228 and a right bank 230. During operation of the mono-fuel engine system 202, the control system 206 can receive one or more inputs from a user and/or one or more sensors within the mono-fuel engine system 202 and control operation of at least one of the internal combustion engine 204, the fuel injector 214, or the actuator 218 via the controller 212.

Referring to FIG. 3, a block diagram of a dual fuel engine system 302 is shown, according to an embodiment. The dual fuel engine system 302 is configured to be an engine having a dual fuel operation mode, such as in which the engine is configured to operate using two different fuels. The engine can be configured to operate using a first fuel and a second fuel (e.g., as described above), where the first fuel and the second fuel have different properties and/or chemical compositions. The properties can include auto-ignition temperatures, flame speeds, etc. The fuels can include diesel and natural gas, as an example. In various embodiments, the dual fuel engine system 302 is configured for one or more oil and gas production applications (e.g., land based oil and/or gas drilling and hydraulic fracturing).

As shown in FIG. 3, the dual fuel engine system includes an internal combustion engine 304, which is operably coupled with a control system 306 via at least one controller 308. The control system 306 can include a machine control system 310. The machine control system can be a control system from an original equipment manufacturer (an OEM system). The control system 306 can further include a first fuel control system 312, and a second fuel control system 314, is configured to send one or more inputs to the controller 308, where the controller 308 then controls the internal combustion engine 304. The engine system 302 can include a hybrid system 318. The hybrid system 318 can be configured to generate power in the engine system 302. In some embodiments, the hybrid system 318 can be used to compensate for power that engine 304 cannot provide in response to a power request.

In some embodiments, the hybrid system 318 can include a battery and an electric machine. In various embodiments the first fuel control system 312 is configured to control a first fuel system 332. The first fuel system 332 and its components are configured to operate using the first fuel. The first fuel system 332 is a fuel delivery system which can include one or more fuel injectors configured to inject the first fuel into the internal combustion engine 304. In some embodiments, the second fuel control system 314 is configured to control a second fuel system 334. The second fuel system 334 and its components are configured to operate using the second fuel. The second fuel system 334 is a fuel delivery system which can include one or more fuel injectors configured to inject the second fuel into the internal combustion engine 304. In some embodiments, the one or more fuel injectors are gas injectors. In some embodiments, the one or more fuel injectors are liquid fuel injectors. For example, in various embodiments, the first fuel control system 312 is a diesel control system and the second fuel control system 314 is a gas control system. In some embodiments, the first fuel control system 312 is a first gas control system and the second fuel control system 314 is a second gas control system. In some embodiments, one or both of the first fuel control system 312 and the second fuel control system 314 can be liquid fuel control systems. In some embodiments, the internal combustion engine 304 can be configured to be fueled by a primary and secondary fuel.

In some embodiments, each of the first fuel control system 312 and the second fuel control system 314 and their respective components can selectively operate using either the first fuel or the second fuel. In various embodiments, the first fuel control system 312 and the second fuel control system 314 cooperatively operate within the internal combustion engine 304.

In various embodiments, the controller 308 is configured to include a processor and a non-transitory computer readable medium (e.g., a memory device) having computer-readable instructions stored thereon that, when executed by the processor, cause the at least one controller 308 to carry out one or more operations. In various embodiments, the at least one controller 308 is a computing device (e.g., a microcomputer, microcontroller, or microprocessor). In some embodiments, the at least one controller 308 is configured as part of a data cloud computing system configured to receive commands from a user control device and/or remote computing device.

The controller 308 can include one or more processors and a memory. The one or more processors can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing a processor, ASIC, FPGA, etc. with program instructions. The memory can include a memory chip, Electrically Erasable Programmable Read-Only Memory (EEPROM), Erasable Programmable Read Only Memory (EPROM), flash memory, or any other suitable memory from which the controller can read instructions. The instructions can include code from any suitable programming language. The memory can include various modules that include instructions which are configured to be executed or otherwise implemented by the one or more processors. The subject matter including the operations described in this specification can be implemented in other types of digital electronic circuitry, or in computer software, firmware, or hardware, including the structures disclosed in this specification and their structural equivalents, or in combinations of one or more of them. The one or more processor and/or memory can be implemented as hardware for performing operations other than control operations, including but not limited to any of various data storage, communication, and/or processing operations.

The controller 308 can be at least partially implemented by or can be communicably coupled with any of various control hardware (not shown) associated with operation of the engine system 302, including but not limited to an engine control unit (ECU) or engine control module (ECM). In some embodiments, the controller 308 can receive or detect one or more signals, such as electrical signals or electronic signals, regarding operation of the engine system 302.

The following description generally relates to a system in which the first fuel control system 312 operates using the first fuel and the second fuel control system 314 operates using the second fuel, however, it should be understood that in some embodiments, each of the first and second fuel control system 312, 314 can be selectively configured to operate using either the first fuel or the second fuel, as described above. The controller 308 can be operably coupled with and at least one actuator 320. In some embodiments, each of the hybrid system 318 and the actuator 320 are operably coupled with the internal combustion engine 304. The actuator 320 can include one or more first fuel type (e.g., diesel type or other liquid type, first gas type) actuators, air handling actuators, aftertreatment actuators, or any other type of actuator within the dual fuel engine system 302. Accordingly, during operation, the controller 308 can send one or more inputs to one or more of the internal combustion engine 304, the hybrid system 318, or the actuator 320 to facilitate a target mode of operation of the dual fuel engine system 302. The controller 308 is described in more detail with respect to FIG. 4.

As shown, the internal combustion engine 304 includes an output shaft 322 and can also include one or more accessories 324. The internal combustion engine 304 further includes at least one manifold 326. In various embodiments, the at least one manifold 326 includes, but is not limited to an intake manifold. The internal combustion engine 304 also includes at least one engine cylinder bank. In some embodiments, the at least one engine cylinder bank includes a left bank 328 and a right bank 333. During operation of the dual fuel engine system 302, the control system 306 can receive one or more inputs from a user and/or one or more sensors within the dual fuel engine system 302. The control system 306 can control operation of at least one of the internal combustion engine 304 or the actuator 320 via the controller 308.

Referring to FIG. 4, a schematic diagram of a controller 400 is shown, according to an embodiment. The controller 400 or one or more components thereof can be included in and/or used to implement one or more devices described herein, e.g., the controller 212 and/or the controller 308. The controller 400 can be structured as one or more electronic control units (ECUs). In some embodiments, the controller 400 includes multiple sub-controllers. In some embodiments, the controller 400 is a distributed controller. As such, the controller 400 can be separate from or included with an engine control unit (e.g., an ECU for the engine system 202 and/or the engine system 302. The controller 400 is configured to communicate with one or more subcomponents of the engine systems 202, 302, including through direct communication, communication over a datalink, and/or through communication with other controllers or portions of the processing subsystem that provide information to the controller 400.

The controller 400 includes a processing circuit 402 having a processor 404 and a memory 406. The controller 400 can include an injector drift monitoring and calibration circuit 408 to determine whether one or more fuel injectors has drifted. The controller 400 can include an injection control circuit 410 configured to determine an adjusted start of injection (SOI) or an adjusted amount of fuel injected by the fuel injectors. The controller 400 can also be configured to determine a number of injection pulses for injection events corresponding to, for example, a pilot injection, a main injection, a post injection, etc. The controller 400 can control the amount of fuel for each injection event, as well as the start of injection for each injection event, and the injection pressure. In some embodiments, the controller 400 additionally includes a communications interface 416 that communicably couples the controller 400 to various other components of the system 100.

In one configuration, the injector drift monitoring and calibration circuit 408 and the injection control circuit 410 are configured by computer-readable media that are executable by a processor, such as the processor 404. As described herein and amongst other uses, the processor 404 has circuitry that facilitates performance of certain operations to enable reception and transmission of data. For example, the circuitry can provide an instruction (e.g., command, etc.) to, e.g., acquire data. In this regard, the circuitry can include programmable logic that defines the frequency of acquisition of the data and/or other aspects of the transmission of the data. In particular, the circuitry can be implemented by computer readable media which can include code written in any programming language including, but not limited to, Java, JavaScript, Python or the like and any conventional procedural programming languages, such as the “C” programming language or similar programming languages. The computer readable program code can be executed on one processor (e.g., processor 404) or multiple remote processors (e.g., multiple processors 404). In the latter scenario, the remote processors can be connected to each other through any type of network (e.g., a controller area network (CAN) bus, etc.).

In some embodiments, a non-transitory processor-readable medium stores code representing instructions to be executed by one or more processors 404, the instructions comprising code to cause the one or more processors 404 to adjust a commanded engine fuel rate corresponding to a target load for an engine based on a comparison of the commanded engine fuel rate and an actual engine fuel rate. In addition, the instructions can further cause the one or more processors 404 to control a first fuel injector of an engine according to a first adjusted injector fuel rate for the first fuel injector. The instructions can further cause the one or more processors 404 to adjust operation of the engine based on the first adjusted injector fuel rate and the target load for the engine. The instructions can further cause the one or more processors 404 to determine a first actual engine power output of the engine while operating the first fuel injector according to the first adjusted injector fuel rate and during the modified operation of the engine. Additionally, the instructions can further cause the one or more processors 404 to adjust a first commanded injector fuel rate for the first fuel injector based on a comparison of the target load and the second actual engine power output.

In some embodiments, a non-transitory processor-readable medium stores code representing instructions to be executed by one or more processors 404, the instructions comprising code to cause the one or more processors 404 to operate a plurality of fuel injectors of the engine according to a commanded engine fuel rate corresponding to a target load for the engine. The plurality of injectors comprises a plurality of primary fuel injectors to supply a primary fuel to the engine and a plurality of secondary fuel injectors to supply a secondary fuel to the engine. The instructions can further cause the one or more processors 404 to adjust the commanded engine fuel rate based on a comparison of the commanded engine fuel rate and an actual engine fuel rate. The instructions can further cause the one or more processors 404 to adjust operation of a first primary fuel injector and a second primary fuel injector of the plurality of primary fuel injectors. Additionally, the instructions can further cause the one or more processors 404 to adjust a commanded injector fuel rate for the first primary fuel injector and the second primary fuel injector fuel based on comparing the target load and an actual engine power output responsive to adjusting the operation of the first primary fuel injector and the second primary fuel injector.

The controller 400 can be configured to select a first fuel injector of the plurality of fuel injectors, adjust operation of the first fuel injector, adjust operation of the engine to provide a power output based on adjusting the operation of the first fuel injector, determine a first actual engine power output of the engine responsive to adjusting the operation of the first fuel injector and the operation of the engine, and adjust a first commanded injector fuel rate of the first fuel injector based on a difference between the first actual engine power output and a target load of the engine. In some embodiments, the controller 400 can be configured to detect a voltage and a current of the generator to determine the first actual engine power output. In some embodiments, the controller 400 can be configured to control the electric motor to provide a power output based on the target load and a reduced engine power output responsive to adjustment of the operation of the first fuel injector.

The controller 400 can operate the first fuel injector of the plurality of fuel injectors according to a parameter (e.g., a commanded fuel rate) corresponding to the target load for the engine, modify operation of the first fuel injector, and control the engine to provide a power output that compensates for the change in engine power resulting from modifying the operation of the first fuel injector. For example, at a light load (e.g.,. a 10% load, a 25% load, a 30% load, etc.), the controller 400 can disable one injector, and control the engine to compensate for the drop in engine power (e.g., to maintain the requested engine power, to maintain the target load) using power from the battery of the hybrid system. In another example, the controller 400 can disable one injector, and increase fueling in the remaining injectors to compensate for the drop in engine power. While adjusting operation of the first fuel injector, the controller 400 can determine the actual fuel rate of the first fuel injector, and compare the actual fuel rate of the first fuel injector to the commanded fuel rate of the first fuel injector. The controller 400 can then adjust the commanded fuel rate of the first fuel injector based on the difference between the actual fuel rate of the first fuel injector and the commanded fuel rate of the first fuel injector (e.g., to obtain the target load). In some embodiments, the controller 400 can repeat this process for each injector in the plurality of fuel injectors.

In some embodiments, such as with larger engines, the controller 400 can modify operation of the first fuel injector to reduce fueling on the first fuel injector and simultaneously increase fueling on a second fuel injector to compensate for the reduced fueling from the first fuel injector. The controller 400 can adjust the fuel rate of the second fuel injector to maintain the requested engine power. The controller 400 can further determine the actual fuel rate of the first fuel injector. In some embodiments, the controller can repeat this process with increasing loads (for example, starting at 25% load and repeating at 50% load). At the higher load, the controller 400 can reduce fueling on the first fuel injector and increase fueling on the second fuel injector accordingly to maintain the requested engine power. The controller 400 can then determine the actual fuel rate of the first fuel injector as well as the actual power delivered by the first fuel injector. For example, if the first fuel injector is turned off during a 25% load, the level of fueling on the first fuel injector is zero. By determining the drop of the total fueling to the engine, then the level of fueling before turning off the first fuel injector can be determined. If the load is increased to a 50% load, for example, and the fueling on the first fuel injector is reduced to the level of fueling before turning off the first fuel injector, the total fueling drop can be measured again. The total fueling drops can be summed to determine the fueling rate before the first fueling drop.

The controller 400 can determine injector drift for each injector based on the difference between the actual fuel rate of each injector and the commanded fuel rate. In some embodiments, the controller 400 can update a fueling table for each injector to compensate for injector drift. In some embodiments, the controller can further generate a signal that injectors are malfunctioning or have excessive drift based on the determined injector drift.

In some embodiments, the injector drift monitoring and calibration circuit 408 and the injection control circuit 410 are embodied as hardware units, such as electronic control units. As such, the injector drift monitoring and calibration circuit 408 and the injection control circuit 410 can be embodied as one or more circuitry components including, but not limited to, processing circuitry, network interfaces, peripheral devices, input devices, output devices, sensors, etc.

In some embodiments, the injector drift monitoring and calibration circuit 408 and the injection control circuit 410 can take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the injector drift monitoring and calibration circuit 408 and the injection control circuit 410 can include any type of component for accomplishing or facilitating achievement of the operations described herein. For example, a circuit as described herein can include one or more transistors, logic gates (e.g., NAND, AND, NOR, OR, XOR, NOT, XNOR, etc.), resistors, multiplexers, registers, capacitors, inductors, diodes, wiring, and so on.

The injector drift monitoring and calibration circuit 408 and the injection control circuit 410 can also include programmable hardware devices such as field programmable gate arrays, programmable array logic, programmable logic devices or the like. In this regard, the injector drift monitoring and calibration circuit 408 and the injection control circuit 410 can include one or more memory devices for storing instructions that are executable by the processor(s) of the injector drift monitoring and calibration circuit 408 and the injection control circuit 410. The one or more memory devices and processor(s) can have the same definition as provided below with respect to the memory 406 and the processor 404. Thus, in this hardware unit configuration, the injector drift monitoring and calibration circuit 408 and the injection control circuit 410 can be dispersed throughout separate locations in the engine system (e.g., as separate control units, etc.). In some embodiments, such as depicted in FIG. 4, the injector drift monitoring and calibration circuit 408 and the injection control circuit 410 can be provided in a single unit/housing, shown as the controller 212, 308.

In the example shown, the processing circuit 402 can be configured to execute or implement the instructions, commands, and/or control processes described herein with respect to one or more of the injector drift monitoring and calibration circuit 408 and the injection control circuit 410. Thus, the depicted configuration represents the aforementioned arrangement where one or more of the injector drift monitoring and calibration circuit 408 and the injection control circuit 410 are embodied as machine or computer-readable media. However, the present disclosure further contemplates embodiments where one or more of the injector drift monitoring and calibration circuit 408 and the injection control circuit 410, or at least one circuit of the injector drift monitoring and calibration circuit 408 and the injection control circuit 410, are configured as hardware. All such combinations and variations are intended to fall within the scope of the present disclosure.

The processor 404 can be implemented as one or more general-purpose processors, an application specific integrated circuit (ASIC), one or more field programmable gate arrays (FPGAs), a digital signal processor (DSP), a group of processing components, or other suitable electronic processing components. In some embodiments, the processor 404 is shared by multiple circuits (e.g., the injector drift monitoring and calibration circuit 408 and the injection control circuit 410 can include or otherwise share the same processor 404 which, in some example embodiments, can execute instructions stored, or otherwise accessed, via different areas of memory 406).

Alternatively, or in combination, the processor 404 can be one of a plurality of processors that is configured to perform or otherwise execute certain operations independent of one or more co-processors. In other example embodiments, two or more processors can be coupled via a bus to enable independent, parallel, pipelined, or multi-threaded instruction execution. All such variations are intended to fall within the scope of the present disclosure.

The memory 406 (e.g., RAM, ROM, Flash Memory, hard disk storage, etc.) can store data and/or computer code for facilitating the various processes described herein. The memory 406 can be communicably connected to the processor 404 to provide computer code or instructions to the processor 404 for executing at least some of the processes described herein. Moreover, the memory 406 can be or include tangible, non-transient volatile memory or non-volatile memory. Accordingly, the memory 406 can include database components, object code components, script components, or any other type of information structure for supporting the various activities and information structures described herein.

The communications interface 416 can include wired and/or wireless interfaces (e.g., jacks, antennas, transmitters, receivers, transceivers, wire terminals, etc.) for conducting data communications with various components of the engine system. For example, the communications interface 416 can include an Ethernet card and port for sending and receiving data via an Ethernet-based communications network and/or a Wi-Fi transceiver for communicating via a wireless communications network. The communications interface 416 can be structured to communicate via local area networks or wide area networks (e.g., the Internet, etc.) and can use a variety of communications protocols (e.g., IP, local area network (LAN), controller area network (CAN), J1939, local interconnect network (LIN), Bluetooth, ZigBee, radio, cellular, near field communication, etc.).

The communications interface 416 of the controller 212, 308 is configured to facilitate communication between and amongst the controller 212, 308 and various components of the engine systems 202 and 302. The communications interface 416 is configured to coordinate the transmission and reception of data between the controller 212, 308, sensors, a human-machine interface (e.g., operator input/output (I/O)), and the components of the engine system that are configured to enable control operation of fuel injection events, including the delivery of fuel to combustion chambers in the engine.

Certain operations described herein include operations to interpret and/or to determine one or more operation parameters. Interpreting or determining, as utilized herein, can include one or more of receiving values from a datalink or network communication, receiving an electronic signal (e.g. a voltage, frequency, current, or PWM signal) indicative of the value, receiving a computer generated operation parameter indicative of the value, reading the value from a memory location on a non-transient computer readable storage medium, receiving the value as a run-time operation parameter by any means known in the art, receiving a value by which the interpreted operation parameter can be calculated, or referencing a default value that is interpreted to be the operation parameter value.

The injector drift monitoring and calibration circuit 408 can be configured to monitor an actual engine power, compare the actual engine power to a target or expected engine power based on a commanded injection event (e.g., a commanded fuel rate corresponding to a target load for the engine), and adjusting calibration of the fuel injectors based on this comparison. In some embodiments, the drift monitoring and calibration circuit 408 is configured to receive sensor input (e.g., sensor data from a sensor or combination of sensors suitable to provide an output of current engine power output). For example, the drift monitoring and calibration circuit 408 can receive sensor data from one or more of a multimeter sensor, an engine speed sensor, or a dynamometer, among other sensors. In some embodiments, when the internal combustion engine 204 drives a generator, the injector drift monitoring and calibration circuit 408 can monitor the electrical power from the alternator or generator. In some embodiments, when the internal combustion engine 204 drives a pump, the injector drift monitoring and calibration circuit 408 can monitor the pump discharge rate and the flow rate through the pump to estimate the power. The flow rate can be estimated from the pump RPM. In some embodiments, the injector drift monitoring and calibration circuit 408 can estimate the power to drive one or more accessories. The one or more accessories can include, but are not limited to, a cooling fan or a hydraulic pump. The power associated with driving the one or more accessories can be measured or estimated separately. In some embodiments, the controller 400 determines the power of the engine to include power for driving the one or more accessories.

In some embodiments, the injector drift monitoring and calibration circuit 408 is configured to receive a calibration parameter or table of calibration parameters. The calibration parameter or table associates the power output of the engine as a function of a commanded injection amount. The injector drift monitoring and calibration circuit 408 can be configured to monitor the power output of the engine to determine whether the calibration parameter is accurate and update the calibration power based on that determination. For example, the injection control circuit 410 can determine an adjustment to the fueling rate based on the updated calibration table.

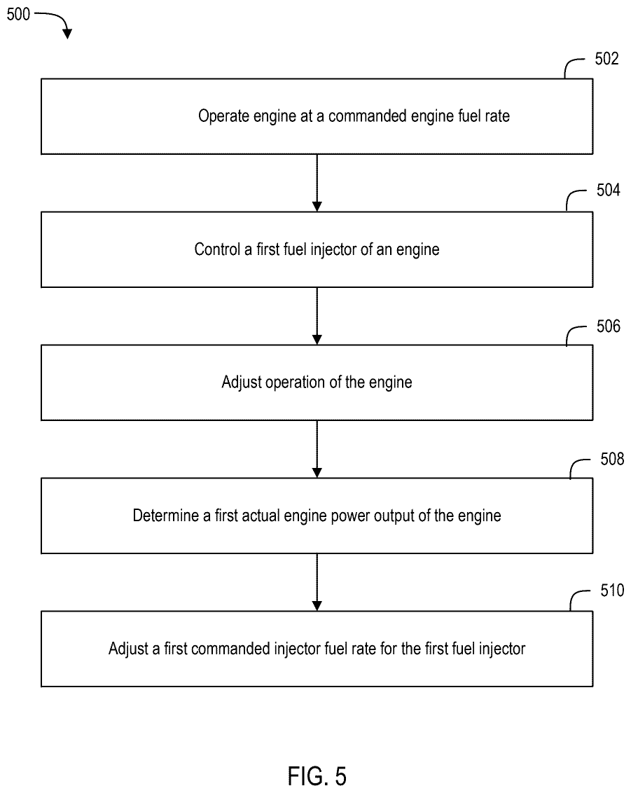

FIG. 5 shows a flow diagram of a method 500 for fuel injector calibration, according to an embodiment. The method 500 can be implemented on any of the engine systems described herein (e.g., the mono-fuel engine system 202 and the dual fuel engine system 302 described with reference to FIGS. 2-3). The method 500 includes: adjusting a commanded engine fuel rate corresponding to a target load for an engine based on a comparison of the commanded engine fuel rate and an actual engine fuel rate; controlling a first fuel injector of an engine according to a first adjusted injector fuel rate for the first fuel injector; adjusting operation of the engine based on the first adjusted injector fuel rate and the target load for the engine; determining a first actual engine power output of the engine while operating the first fuel injector according to the first adjusted injector fuel rate and during the modified operation of the engine; and adjusting a first commanded injector fuel rate for the first fuel injector based on a comparison of the target load and the second actual engine power output. In some embodiments, controlling the first fuel injector according to the first adjusted injector fuel rate includes disabling the first fuel injector or operating the first fuel injector at a partial level relative to a maximum operating capacity of the first fuel injector. In some embodiments, adjusting operation of the engine includes providing a power output to compensate for a reduced engine power output during operation of the first fuel injector according to the first adjusted injector fuel rate. In some embodiments, adjusting operation of the engine includes controlling a second fuel injector of the plurality of fuel injectors to compensate for a reduced engine power output during operation of the first fuel injector according to the first adjusted injector fuel rate. In some embodiments, adjusting operation of the engine includes operating the first fuel injector to supply a primary fuel to the engine according to the first adjusted injector fuel rate. Adjusting operation can further include operating a second fuel injector of the plurality of fuel injectors to supply a secondary fuel to compensate for a reduced engine power output during operation of the first fuel injector. In some embodiments, adjusting the first commanded injector fuel rate for the first fuel injector includes updating at least one of a function associated with the first commanded injector fuel or a lookup table associated with the first commanded injector fuel rate.

In some embodiments, the method 500 can further include controlling a second fuel injector of the engine according to a second adjusted injector fuel rate for the second fuel injector, adjusting operation of the engine based on the second adjusted injector fuel rate and the target load, determining a second actual engine power output of the engine while operating the second fuel injector according to the second adjusted injector fuel rate and during the modified operation of the engine, and adjusting a second commanded injector fuel rate for the second fuel injector based on a comparison of the target load and the second actual engine power output. In some embodiments, the method 500 can further include controlling the first fuel injector based on the adjusted first commanded injector fuel rate.

Operation 502 includes adjusting a commanded engine fuel rate based on a comparison of the commanded engine fuel rate and an actual engine fuel rate. The commanded engine fuel rate corresponds to a target load (e.g., a requested engine power output) for an engine. Operation 502 can include actuating or causing a plurality of fuel injectors to release a certain amount of fuel into the combustion chamber of an engine based on a first target load for an engine. In some embodiments, the amount of fuel injected can be determined according to a parameter (e.g., calibration parameter) for the fuel injector corresponding to the first target load. For example, the parameter and/or a table (e.g., fueling table, lookup table) representing the parameter can indicate a value (e.g., voltage, etc.) of a control signal to provide to the fuel injector to cause the fuel injector to output fuel at a commanded fuel rate. Operation 502 can include determining an actual engine power output of the engine while operating the plurality of fuel injectors according to the commanded engine fuel rate and determining an actual engine fuel rate of the engine based on the actual engine power output. The commanded engine fuel rate can be adjusted based on a total error (e.g., difference) between the actual engine fuel rate and the commanded engine fuel rate. Operation 502 can include updating (e.g., correcting) a fueling table of the engine to compensate for the error. Operation 502 can be used to estimate an error between a commanded fuel rate and an actual rate for the whole engine. Error caused by individual injectors are assessed in operations 504-510.

Operation 504 includes controlling a first fuel injector of an engine according to a first adjusted injector fuel rate for the first fuel injector. In some embodiments, the adjusted injector fuel rate for the first fuel injector can be decreased or increased relative to a commanded injector fuel rate for the first fuel injector. Controlling the first fuel injector of the engine according to the first adjusted injector fuel rate can include modifying the operation of the first fuel injector. In some embodiments, modifying the operation of the first fuel injector can include disabling the fuel injector (e.g., such that the fuel injector does not provide any fuel). Modifying operation of the fuel injector can cause the power output of the engine to reduce below the requested engine power. In such a case, the loss in power output for the engine can be compensated for in operation 506.

Operation 506 includes adjusting operation of the engine based on the first adjusted injector fuel rate and the target load for the engine. Operation 506 can include compensating for a reduced engine power output during the modified operation of the first fuel injector. The engine can be commanded to produce an amount of power to meet the requested power demand (e.g., the target load) such that the engine power output is constant. For example, the method 500 can include operating the engine to provide a power output to compensate for a reduced engine power output resulting from modifying operation of the first fuel injector. In some embodiments, the compensating power output can be provided by increasing the fuel rate of a second fuel injector. For example, if a first fuel injector is disabled, a fuel rate for a second fuel injector can be increased accordingly to maintain the target load (e.g., to keep the engine power output constant). In some embodiments, the compensating power output can be provided by increasing the fuel rate of a plurality of fuel injectors. In some embodiments, where the engine is unable to meet the requested power demand, a hybrid system including a battery and an electric motor can provide the compensating power output. When power output is provided by a battery, the amount of power provided is known and controlled such that an actual fuel rate of the injector can be determined.

Operation 508 includes determining a first actual engine power output of the engine while operating the first fuel injector according to the first adjusted injector fuel rate and during the modified operation of the engine. For example, the first adjusted injector fuel rate may be reduced to zero (e.g., disabling the first fuel injector) in operation 504. In operation 506, the operation of the engine can be adjusted to compensate for the first adjusted injector fuel rate based on an estimate of the expected reduction engine power output from disabling the first fuel injector. The engine power output including the compensating power output can be used to determine the actual engine power output of the engine while the first fuel injector is disabled. For example, the engine can produce a power output that corresponds to the amount of expected engine power output loss caused by disabling a fuel injector. The engine power output with the disabled fuel injector in addition to the compensating power output may be less than the requested engine power output. The difference needed to obtain the requested engine power output can be used to assess injector drift in the disabled fuel injector, and thus can be used to assess whether a fuel injector is performing properly (e.g., is defective).

Operation 510 includes adjusting a first commanded injector fuel rate for the first fuel injector based on a comparison of the target load and the second actual engine power output. Operation 510 can include updating a fueling table for the first fuel injector such that the adjusted commanded injector fuel rate compensates for injector drift. For example, the adjusted commanded injector fuel rate for the first fuel injector can account for under fueling or over fueling caused by injector drift.

In some embodiments, the method 500 can be repeated for each fuel injector in the plurality of fuel injectors, and can be repeated at different engine loads.

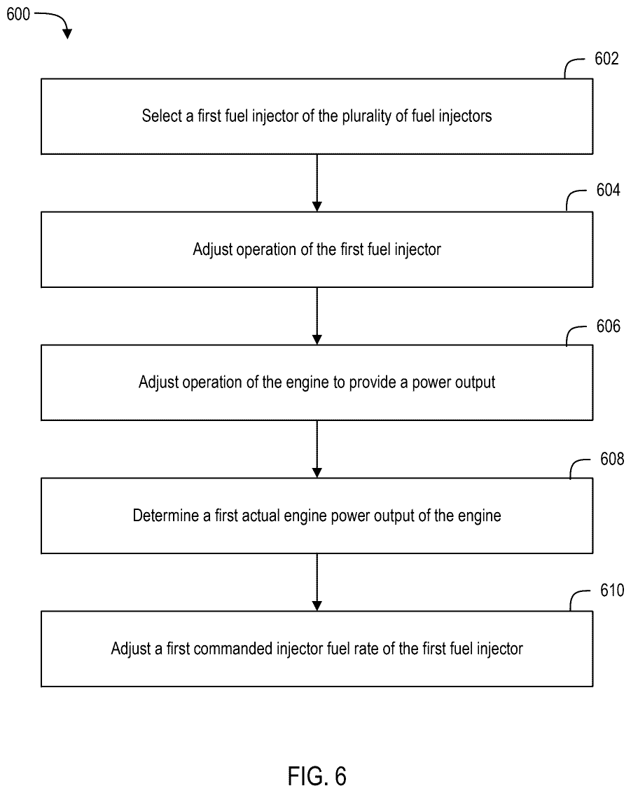

FIG. 6 shows a flow diagram of a method 600 for calibrating fuel injection within an engine system, according to an embodiment. The method 600 can be used to calibrate fuel injection in any of the engine systems described herein (e.g., the mono-fuel engine system 202 and the dual fuel engine system 302 described with reference to FIGS. 2-3). The method 600 can be executed by a controller (e.g., controller 400). The method 600 includes: selecting a first fuel injector of the plurality of fuel injectors; adjusting operation of the first fuel injector; adjusting operation of the engine to provide a power output based on adjusting the operation of the first fuel injector; determining a first actual engine power output of the engine responsive to adjusting the operation of the first fuel injector and the operation of the engine; and adjusting a first commanded injector fuel rate of the first fuel injector based on a difference between the first actual engine power output and a target load of the engine. In some embodiments, the engine is configured to be fueled by a primary fuel and a secondary fuel. In some embodiments, adjusting the first commanded fuel injector rate includes sending a command to update at least one of a function associated with the first commanded fuel injector rate or a lookup table associated with the first commanded fuel injector rate. In some embodiments, adjusting operation of the first fuel injector includes reducing a fuel rate to the first fuel injector and adjusting operation of the engine by increasing a fuel rate to one or more fuel injectors in the plurality of injectors. In some embodiments, the first fuel injector is selected based on at least one of an engine vibration, an engine emission output, or an engine temperature.

In some embodiments, a hybrid system including an electric motor and a battery is provided, and the method 600 includes controlling the electric motor to provide a power output based on the target load and a reduced engine power output responsive to adjustment of the operation of the first fuel injector. In some embodiments, a generator configured to be driven by the engine is provided, and the method 600 includes detecting a voltage and a current of the generator to determine the first actual engine power output. In some embodiments, the method 600 further includes providing a signal indicating a defective injector in response to a difference between an adjusted first commanded injector fuel rate and the first commanded fuel injector rate being greater than an error margin.

Operation 602 includes selecting a first fuel injector of the plurality of fuel injectors. Selecting the first fuel injector can be based on effects caused by modifying operation of the first fuel injector. For example, modifying operation of the first fuel can cause engine vibration, changes to particulate emissions, and changes to exhaust temperature. For example, the controller can continuously monitor engine parameters (e.g., injector performance, fuel rates, engine speed, load, emissions, etc.) and select a first fuel injector based on detected engine parameters.

Operation 604 includes adjusting operation of the first fuel injector. Adjusting operation of the first fuel injector can include modifying the operation of the first fuel injector. In some embodiments, modifying the operation of the first fuel injector can include disabling the fuel injector (e.g., such that the fuel injector does not provide any fuel). In some embodiments, modifying the operation of the first fuel injector can include decreasing a fuel rate of the first fuel injector. Modifying operation of the fuel injector can cause the power output of the engine to reduce below the requested engine power.

Operation 606 includes adjusting operation of the engine to provide a power output based on adjusting the operation of the first fuel injector. Operation 606 can include compensating for a reduced engine power output during the modified operation of the first fuel injector. The engine can be commanded to produce an amount of power to meet the requested power demand (e.g., the target load). For example, the method 600 can include operating the engine to provide a power output to compensate for a reduced engine power output resulting from modifying operation of the first fuel injector. In some embodiments, an engine system includes two sources of mechanical power (e.g., an internal combustion engine and an electric motor coupled to a battery) which can be used to provide power to compensate for reduced engine power. In some embodiments, the compensating power output can be provided by increasing the fuel rate of a second fuel injector. For example, if a first fuel injector is disabled, a fuel rate for a second fuel injector can be increased accordingly to maintain the target load (e.g., to keep the engine power output constant). In some embodiments, the compensating power output can be provided by increasing the fuel rate of a plurality of fuel injectors. In some embodiments, where the engine is unable to meet the requested power demand, a hybrid system including a battery and an electric motor can provide the compensating power output.

Operation 608 includes determining a first actual engine power output of the engine responsive to adjusting the operation of the first fuel injector and the operation of the engine. For example, a controller can estimate and/or calculate an actual engine power output.

Operation 610 includes adjusting a first commanded injector fuel rate of the first fuel injector based on a difference between the first actual engine power output and a target load of the engine. Operation 610 can include updating a fueling table for the first fuel injector such that the adjusted commanded injector fuel rate compensates for injector drift. For example, the adjusted commanded injector fuel rate for the first fuel injector can account for under fueling or over fueling caused by injector drift. In some embodiments, the method 600 can be repeated for each fuel injector in the plurality of fuel injectors.

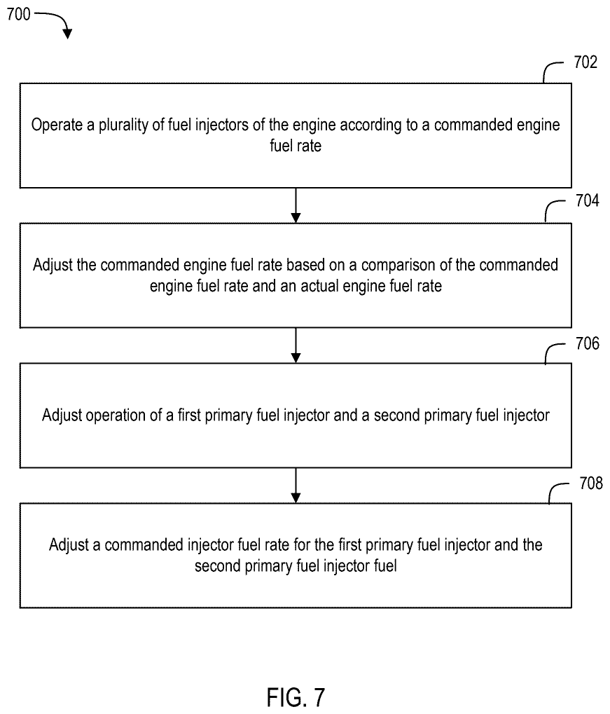

FIG. 7 shows a flow diagram of a method 700 for calibrating fuel injection for a dual fuel engine system (e.g., the dual fuel engine system 302 described in FIG. 3), according to an embodiment. The method 700 includes operating a plurality of fuel injectors of the engine according to a commanded engine fuel rate corresponding to a target load for the engine, wherein the plurality of injectors comprises a plurality of primary fuel injectors to supply a primary fuel to the engine and a plurality of secondary fuel injectors to supply a secondary fuel to the engine; adjusting the commanded engine fuel rate based on a comparison of the commanded engine fuel rate and an actual engine fuel rate; adjusting operation of a first primary fuel injector and a second primary fuel injector of the plurality of primary fuel injectors; and adjusting a commanded injector fuel rate for the first primary fuel injector and the second primary fuel injector fuel based on comparing the target load and an actual engine power output responsive to adjusting the operation of the first primary fuel injector and the second primary fuel injector. In some embodiments, adjusting the operation of the first primary fuel injector and the second primary fuel injector includes increasing a fuel rate of the first primary fuel injector and decreasing a fuel rate of the second primary fuel injector.

In some embodiments, the method 700 further includes adjusting operation of a first secondary fuel injector and a second secondary fuel injector of the plurality of secondary fuel injectors, and adjusting a commanded injector fuel rate for the first secondary fuel injector and the second secondary fuel injector based on comparing the target load and an actual engine power output of the engine responsive to adjusting the operation of the first secondary fuel injector and the second secondary fuel injector. In some embodiments, the method 700 further includes adjusting operation of at least one primary fuel injector of the plurality of primary fuel injectors to provide a power output to compensate for a reduced engine power output caused by adjusting the first secondary fuel injector and the second secondary fuel injector.

Operation 702 includes operating a plurality of fuel injectors of the engine according to a commanded engine fuel rate corresponding to a target load for the engine, wherein the plurality of injectors comprises a plurality of primary fuel injectors to supply a primary fuel to the engine and a plurality of secondary fuel injectors to supply a secondary fuel to the engine. In some embodiments, the primary fuel is diesel, and the secondary fuel is methanol. Operation 702 can include actuating or causing the plurality of fuel injectors to release a certain amount of fuel into the combustion chamber of an engine based on a target load for an engine. In some embodiments, the amount of fuel injected can be determined according to a calibration parameter or table for the plurality of fuel injectors corresponding to the target load. The calibration parameter or table maps the power output of the engine as a function of a commanded injection amount.

Operation 704 includes adjusting the commanded engine fuel rate based on a comparison of the commanded engine fuel rate and an actual engine fuel rate. Operation 704 can include adjusting the commanded engine fuel rate based after determining an actual engine fuel rate of the engine while operating the plurality of fuel injectors according to the commanded engine fuel rate. In some embodiments, the commanded engine fuel rate is adjusted based on an estimated error between the commanded engine fuel rate and the actual engine fuel rate. In some embodiments, operation 704 can include updating fueling tables for the engine to compensate for the error.

Operation 706 includes adjusting operation of a first primary fuel injector and a second primary fuel injector of the plurality of primary fuel injectors. Operation 706 includes modifying operation of the first primary fuel injector and the second primary fuel injector (e.g., a primary fuel pair). In some embodiments, modifying the operation of a fuel injector can include increasing the commanded fuel rate on the first primary fuel injector, while simultaneously decreasing the commanded fuel rate on the second primary fuel injector. In some embodiments, the increased commanded fuel rate in the first primary fuel injector is equal to the decreased commanded fuel rate in the second primary injector. For example, when the commanded fuel rate for the first primary injector is increased by a first amount, the commanded fuel rate for the second primary fuel injector is decreased by that same first amount. In some embodiments, the increased commanded fuel rate in the first primary fuel injector is not equal to the decreased commanded fuel rate in the second primary fuel injector.

Operation 708 includes adjusting a commanded injector fuel rate for the first primary fuel injector and the second primary fuel injector fuel based on comparing the target load and an actual engine power output responsive to adjusting the operation of the first primary fuel injector and the second primary fuel injector. After adjusting the operation of the first primary fuel injector and the second primary fuel injector, changes in engine power output can be monitored and the commanded injector fuel rate for the primary fuel injectors can be adjusted to maintain a constant engine power output (e.g., the requested engine power output). Operation 708 can include updating a fueling table for the first primary fuel injector such that the adjusted commanded injector fuel rate compensates for injector drift. For example, the adjusted commanded injector fuel rate for the first primary fuel injector can account for under fueling or over fueling caused by injector drift. Operations 706 and 708 can be repeated with additional pairs of primary fuel injectors.

In some embodiments, the method 700 can be used to calibrate the plurality of primary fuel injectors of the primary fuel system of the dual fuel engine, and subsequently used to calibrate the plurality of secondary fuel injectors of the secondary fuel system of the dual fuel engine. Operations 706 and 708 can be repeated for the secondary fuel system of the dual fuel engine to calibrate the plurality of secondary fuel injectors. For example, operation 706 can include the first secondary fuel injector and the second secondary fuel injector. A reduction in power output caused by modifying operation of the first secondary fuel injector and the second secondary fuel injector can be compensated for by adjusting operation of one or more of the plurality of primary fuel injectors. For example, if a secondary fuel injector is disabled, increased fueling to a primary fuel injector can be used to compensate for the reduction in engine power output. In some embodiments, the primary fuel system is a diesel system and the secondary fuel system is a methanol system.

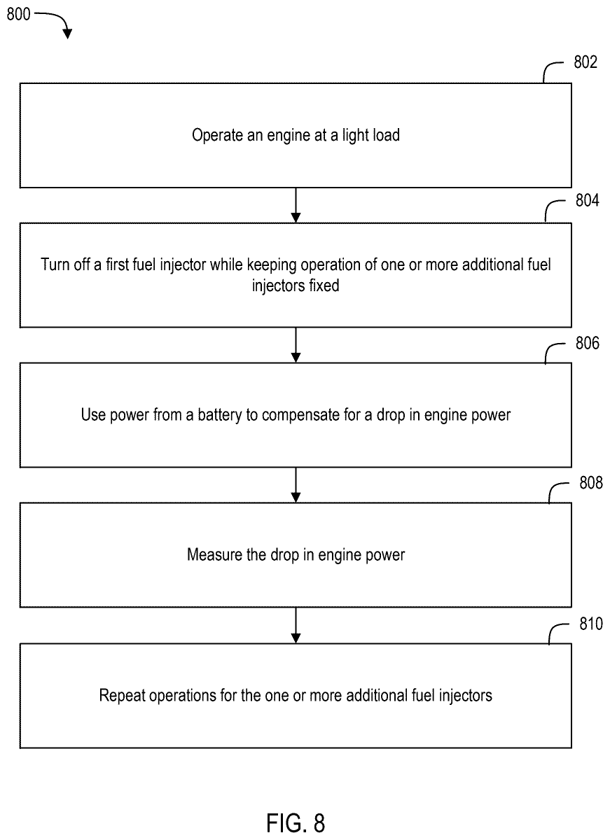

FIG. 8 shows a flow diagram of a method 800 for fuel injector calibration, according to an embodiment. The operations of the method 800 of FIG. 8 can be used in combination with, or instead of, any of the operations of FIGS. 5-7.

Operation 802 can include operating the engine at a light load (e.g., 25% load, 10% load, under 50% load, etc.). In some embodiments, operation 802 is performed in diesel-only mode. Operation 804 includes turning off a first fuel injector. Operation 804 can also include keeping operation of one or more additional fuel injectors fixed. Turning off the first fuel injector can cause a drop in engine power. In most cases, a drop in engine power is not desired, however, the method 800 can beneficially allow for operation of the engine in such a manner to determine how to compensate for the drop in engine power.

Operation 806 can include using power from the battery (or another power source) to compensate for the drop in engine power caused by operation 804. Operation 806 can allow the requisite total power to be delivered to the system while fuel injector calibration is performed. In some embodiments, such as in a hybrid system, the engine can run in a steady state mode utilizing constant torque and constant RPM, and the battery handles the transient power requirements. Some embodiments may not include operation 806, as further described herein.

Operation 808 can include measuring the drop in engine power caused by operation 804. The drop in engine power may be measured in several ways. For example, the drop in engine power can be measured by determining a change in the net engine power. As another example, the drop in engine power can be measured by measuring how much power is provided by the battery to keep the requisite total power constant. Additionally, to measure the drop in engine power, fueling from the one or more additional fuel injectors can be increased to estimate how much the engine power dropped from turning off the first fuel injector, by determining how much more fuel is needed from the one or more additional fuel injectors. In some embodiments, the controller can update a lookup table with a measurement obtained by measuring the drop in engine power caused by turning off the first fuel injector. In some embodiments, as an alternative to battery power, the one or more additional fuel injectors may be used to compensate for the drop in engine power. Operation 810 includes repeating operations 802-808 for each of the additional fuel injectors.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining can be stationary (e.g., permanent) or moveable (e.g., removable or releasable). Such joining can be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although certain embodiments have been described in detail in this disclosure, those skilled in the art who review this disclosure will readily appreciate that various modifications are possible without materially departing from the novel teachings and advantages of the subject matter described herein. Other substitutions, modifications, changes and omissions can also be made in the design and arrangement of the various exemplary embodiments without departing from the scope of the embodiments described herein.

While this specification contains specific implementation details, these should not be construed as limitations on the scope of any embodiment or of what can be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

What is claimed is:

1. A method of fuel injector calibration, the method comprising:
operating an engine at a given operating condition, the given operating condition including a commanded engine fuel rate;
controlling a first fuel injector of an engine according to a first adjusted injector fuel rate for the first fuel injector;
adjusting operation of the engine based on the first adjusted injector fuel rate and a target load for the engine;
determining a first actual engine power output of the engine while operating the first fuel injector according to the first adjusted injector fuel rate and during the adjusted operation of the engine; and
adjusting a first commanded injector fuel rate for the first fuel injector based on a comparison of a target load and the first actual engine power output.

2. The method of claim 1, further comprising:
controlling a second fuel injector of the engine according to a second adjusted injector fuel rate for the second fuel injector;
adjusting operation of the engine based on the second adjusted injector fuel rate and the target load;
determining a second actual engine power output of the engine while operating the second fuel injector according to the second adjusted injector fuel rate and during the modified operation of the engine; and
adjusting a second commanded injector fuel rate for the second fuel injector based on a comparison of the target load and the second actual engine power output.

3. The method of claim 1, further comprising:
controlling the first fuel injector based on the adjusted first commanded injector fuel rate.

4. The method of claim 1, wherein controlling the first fuel injector according to the first adjusted injector fuel rate comprises disabling the first fuel injector or operating the first fuel injector at a partial level relative to a maximum operating capacity of the first fuel injector.

5. The method of claim 1, wherein adjusting operation of the engine comprises:
providing a power output to compensate for a reduced engine power output during operation of the first fuel injector according to the first adjusted injector fuel rate.

6. The method of claim 1, wherein adjusting operation of the engine comprises:
controlling a second fuel injector of the plurality of fuel injectors to compensate for a reduced engine power output during operation of the first fuel injector according to the first adjusted injector fuel rate.

7. The method of claim 1, wherein:
adjusting operation of the engine comprises operating the first fuel injector to supply a primary fuel to the engine according to the first adjusted injector fuel rate, and operating a second fuel injector of the plurality of fuel injectors to supply a secondary fuel to compensate for a reduced engine power output during operation of the first fuel injector.

8. The method of claim 1, wherein adjusting the first commanded injector fuel rate for the first fuel injector comprises updating at least one of a function associated with the first commanded injector fuel or a lookup table associated with the first commanded injector fuel rate.

9. A calibration system for a plurality of fuel injectors of an engine, comprising:
a controller configured to:
select a first fuel injector of the plurality of fuel injectors;
adjust operation of the first fuel injector;
adjust operation of the engine to provide a power output based on adjusting the operation of the first fuel injector;
determine a first actual engine power output of the engine responsive to adjusting the operation of the first fuel injector and the operation of the engine; and
adjust a first commanded injector fuel rate of the first fuel injector based on a difference between the first actual engine power output and a target load of the engine.

10. The calibration system of claim 9, further comprising a hybrid system including an electric motor and a battery, wherein the controller is configured to control the electric motor to provide a power output based on the target load and a reduced engine power output responsive to adjustment of the operation of the first fuel injector.

11. The calibration system of claim 9, wherein the engine is configured to be fueled by a primary fuel and a secondary fuel.

12. The calibration system of claim 9, wherein the controller is further configured to:
in response to a difference between an adjusted first commanded injector fuel rate and the first commanded fuel injector rate being greater than an error margin, provide a signal indicating a defective injector.

13. The calibration system of claim 9, wherein the calibration system further comprises a generator configured to be driven by the engine, wherein the controller is further configured to detect a voltage and a current of the generator to determine the first actual engine power output.

14. The calibration system of claim 9, wherein the controller is configured to adjust the first commanded fuel injector rate by sending a command to update at least one of a function associated with the first commanded fuel injector rate or a lookup table associated with the first commanded fuel injector rate.

15. The calibration system of claim 9, wherein the controller is configured to adjust operation of the first fuel injector by reducing a fuel rate to the first fuel injector and adjust operation of the engine by increasing a fuel rate to one or more fuel injectors in the plurality of injectors.

16. The calibration system of claim 9, wherein the controller is configured to select a first fuel injector based on at least one of an engine vibration, an engine emission output, or an engine temperature.

17. A method of calibrating fuel injection for a system including an engine, the method comprising:
operating the engine at a target load;
operating a plurality of fuel injectors of the engine;
turning off a first fuel injector of the plurality of fuel injectors;
compensating for a drop in engine power caused by turning off the first fuel injector by using power from a battery;
measuring the drop in engine power caused by turning off the first fuel injector; and
repeating the preceding operations for each of the plurality of fuel injectors.

18. The method of claim 17, further comprising keeping operation of at least one of the plurality of fuel injectors fixed, optionally wherein keeping the operation of the at least one of the plurality of fuel injectors fixed comprises keeping a fuel rate of the at least one of the plurality of fuel injectors fixed.

19. The method of claim 17, further comprising adjusting operation of at least one fuel injector of the plurality of fuel injectors to provide a power output to compensate for a reduced engine power output caused by turning off the first fuel injector.

20. The method of claim 17, further comprising updating a lookup table with a measurement obtained by measuring the drop in engine power caused by turning off the first fuel injector.
